(19) United States
(12) Patent Application Publication
(10) Pub. No.: US 2016/0212087 A1
(43) Pub. Date: Jul. 21, 2016

(54) MESSAGE SYSTEM

(71) Applicant: Paul Damian NELSON, South Yarra, Victoria (AU)

(72) Inventor: Paul Damian NELSON, South Yarra, Victoria (AU)

(21) Appl. No.: 14/915,379

(22) PCT Filed: Aug. 29, 2014
(86) PCT No.: PCT/AU2014/000853

§ 371 Date: Feb. 29, 2016

(30) Foreign Application Priority Data
Aug. 29, 2013 (AU) 2013903288
Jan. 9, 2014 (AU) 2014900064

(51) Int. Cl. H04L 12/58

(52) U.S. Cl. CPC H04L 51/28; H04L 51/36; H04L 51/12

(57) ABSTRACT

The present invention relates to a new message system, including various methods, systems, processes, applications, and products relating to same. In one embodiment, a new message system allows a user to customize the appearance of at least a field in an email, such as email address. In other example message systems, such as social media or social networks, and so on, a user is able to customize the appearance of their identification displayed (“ID”) to another party, such as their contact address or ID. Such customization, for commercial level, could provide for inclusion and emphasis of for example, trade mark exposure. Such customization examples, can be managed, for example, by a user of a registration service database that stores customization design(s): and provides and applies same to visual end use.

### FIELD OF THE INVENTION

The present invention is generally related to a method of providing customization of at least one displayed field in a message system, such as, for example, an email system. It is convenient to describe the invention mainly in relation to an email system, but it is to be appreciated that the invention is not limited to such application, and is to include many other message systems, including for example, numerous message systems including social media and social networks, computer text and telephone text message systems, telephone calls, or any other message system.

### BACKGROUND TO THE INVENTION

This document claims priority of 1) Australian Provisional Application, with IP Right Number 2013903288 submitted on 29 Aug. 2013, with title “APPARATUS”; and 2) Australian Provisional Application, with IP Right Number 2014900064 submitted on 9 Jan. 2014, with title “METHOD OF AN EMAIL SYSTEM”.

Since its inception, email has revolutionized the manner in which individuals and business communicate as it allows for virtually instantaneous communication between sender and recipient at a fraction of the cost of traditional mail services. However, the ease and relative low cost of email communications have also led to a number of problems, including but not limited to the information overload experienced by many email users as a result of the sheer number of emails that may be received by email account holders each day. The information overload experienced by email account holders can often make it difficult for an account holder to determine which emails received are from known or relevant senders, whether the sender's credentials are authentic, which organisation, company, group, or individual the recipient may have received emails from etc.

Accordingly, there is a need for improvements to existing messaging systems.

### SUMMARY OF THE INVENTION

In a first broad aspect the invention provides a method of providing customization of at least one displayed field in a receiver message system, the method comprising:
receiving a message at a receiver message system, the message comprising at least a field and a body;
sending a request for custom data from the receiver message system to a message customization registration service, the request for custom field data comprising information indicative of at least a portion of an address contained in a field;
receiving custom data from the message customization registration service at the receiver message system upon the at least a portion of the address being registered with the message customization registration service, wherein the custom data relates to at least one of a desired appearance of data in at least one displayed field and an action that can be performed with respect to the at least one displayed field; and
controlling at least one of the appearance of the contents of the at least one displayed field and an action that can be performed with respect to the at least one displayed field when the message is displayed by the message system based on the custom data.

In an embodiment, the message system is an email system and the address is an email address and information indicative of at least a portion of an email address is a domain name that forms part of the email address and custom data is received if the domain name is registered with the message customization registration service.

In another embodiment, the message system is a social media or social network system, an SMS (short message service) or text message system, a telephone call system, or any other message system, and the address is the “ID” (the “ID” being the identification number, address, or contact detail(s)) wherein custom data is received if at least part of the ID that forms part of the address is registered with the message customization registration service.

In an embodiment, the method comprises:
receiving a negative response from the message customization registration service at the receiver message system if the information indicative of at least a portion of a message address is not registered with the message customization registration service; and
displaying each displayed field in a default font in response to the negative response.

In an embodiment, custom data related to an action that can be performed with respect to the at least one displayed field which comprises a URL placed in the at least, one displayed field to enable a user to access a pop-up and or a web page corresponding to the URL by operating a user interface to select the URL.

In an embodiment, the method comprises storing the custom data in a local database of the receiver message system.

In an embodiment, the method comprises searching the local database for any stored custom data corresponding to the information indicative of at least a portion of an address prior to sending the request to the message customization registration service, and controlling at least one of the appearance of the contents of the at least one displayed field and an action that can be performed with respect to the at least one displayed field when the message is displayed by the message system based on any stored custom data located in the search.

In a second broad aspect the invention provides computer program code which when executed implements the method of the first broad aspect.

In a third broad aspect the invention provides a computer readable medium comprising the computer program code of the second broad aspect.

In a fourth broad aspect the invention provides a message customization registration service comprising:
a database of custom field data indexed by at least a portion of an address, wherein a custom field data entry relates to at least one of a desired appearance of data in at least one displayed field and an action that can be performed with respect to the at least one displayed field and can be used by a receiver message system to control at least one of the appearance of the contents of the at least one displayed field and an action that can be performed with respect to the at least one displayed field when the message is displayed to a user by the receiver message system; and
the message customization registration service being arranged to receive a request for custom field data from a receiver message system comprising information indicative of at least a portion of a field or address, search the database of custom field data based on the received information indicative of at least a portion of an address, and send any located custom field data to the sender and or receiver message system based on the received custom data.

In an embodiment, the message system is an email system and the address is an email address and wherein the at least a portion of an address comprises a domain name.

In an embodiment, the message system is a social media or social network system, an SMS (short message service) or text message system, a telephone call system, or any other message system, and the address is the “ID” (the “ID” being the identification number, address, or contact detail(s)) wherein custom data is received if at least part of the ID that forms part of the address is registered with the message customization registration service.

In an embodiment, the request for custom field data comprises the entire address, and the customization registration service is arranged to extract at least one portion from the entire address to search the database.

In a fifth broad aspect the invention provides computer program code which when executed implements the method of the fourth broad aspect.

In a sixth broad aspect the invention provides computer readable medium comprising the computer program code of the fifth broad aspect.

In a seventh broad aspect the invention provides a computer based system comprising a receiver message system arranged to:
receive a message, the message comprising at least a field and a body:
send a request for custom data from the message system to a message customization registration service, the request for custom data comprising information indicative of at least a portion of an address;
receive custom data from the message customization registration service upon the at least a portion of the address being registered with the message customization registration service, wherein the custom data relates to at least one of a desired appearance of data in at least one displayed field and an action that can be performed with respect to the at least one displayed field; and
control at least one of the appearance of the contents of the at least one displayed field and an action that can be performed with respect to the at least one displayed field when the message is displayed to a user by the message system based on the received custom data.

In an embodiment, the message system is an email system and the address is an email address and the information indicative of at least a portion of an email address is a domain name that forms part of the email address and custom data is received if the domain name is registered with the message customization registration service.

In an embodiment, the message system is a social media or social network system, an SMS (short message service) or text message system, a telephone call system, or any other message system, and the address is the “ID” the “ID” being the identification number, address, or contact detail(s)) wherein custom data is received if at least part of the ID that forms part of the address is registered with the message customization registration service.

In an embodiment, the receiver message system is arranged to:
receive a negative response from the message customization registration service if the information indicative of at least a portion of an address is not registered with the customization registration service; and
display at least a displayed field in a default font in response to the negative response.

In an embodiment, custom data related to an action that can be performed with respect to the at least one displayed field comprises a URL placed in the at least one displayed field to enable a user to access a pop-up and or web page corresponding to the URL by operating a user interface to select the URL.

In an embodiment, the computer based system comprises a message customization registration service comprising a database of custom field data indexed by at least a portion of an address, the message customization service arranged to receive a request for custom field data from a sender or receiver message system, search the database of custom field data based on the received information indicative of at least a portion of an address, and send any located custom field data to the receiver message system.

In an embodiment, the message system is an email system and the address is an email address and the at least a portion of an email address comprises a domain name.

In an embodiment, the request for custom field data comprises an entire email address, and the message customization registration service is arranged to extract at least one portion from the entire email address to search the database.

In an embodiment, the receiver message system comprises a local database, and the receiver message system is arranged to store the custom data in the local database.

In an embodiment, the receiver message system is arranged to search the local database for any stored custom data corresponding to the information indicative of at least a portion of an address prior to sending the request to the message customization registration service, and control at, least one of the appearance of the contents of the at least one displayed field and an action that can be performed with respect to the at least one displayed field when the message is displayed to a user by the receiver message system based on any stored custom data located in the search.

In an eighth broad aspect the invention provides computer program code which when executed implements the method of the seventh broad aspect.

In a ninth broad aspect the invention provides computer readable medium comprising the computer program code of the eighth broad aspect.

### BRIEF DESCRIPTION OF THE FIGURES

Embodiments of the invention will now be described by way of example with reference to the accompanying Figures in which:

FIG. 1 is a schematic diagram of a message system for customization of at least a portion of displayed field;

FIG. 2 is a schematic diagram representing how a user registers for custom data relating to customization of a field in a message system;

FIG. 3 shows different customized design examples of fields, such as email addresses;

FIG. 4 shows a customized design layout of a field, being an email address;

FIG. 5 shows customized design layouts of fields, being email addresses;

FIG. 6 shows a customized design layout of a field, being an email address;

FIG. 7 shows a customized design layout of a field, being an email address;

FIG. 8 shows a customized design layout of a field, being an email address;

FIG. 9 is a schematic diagram of a message system for customization of at least a portion of a field, relating to social media or social network message systems; and

FIG. 10 shows a customized design layout of a field, relating to a social media or social network message system.

### DETAILED DESCRIPTION OF EMBODIMENTS OF THE INVENTION

The invention is generally related to a method of providing customization of at least one displayed field in a messaging system such as an email system. In one example, the displayed field is the from field. Embodiments provide for controlling a desired appearance of a displayed field by displaying one or more fields in a customized design such as a desired font or a customized image or images in a receiver email system. For example, the sender's name or email address may be displayed in a custom font used by their company, group or organisation. This may provide, for example, branding or a look and feel of an email that is consistent with, for example, a branding scheme, or is at least desired, for example, by the email manager, director, or user of the email system.

Customizing the appearance of emails sent from an email account may help visually differentiate emails sent from said account from other, unrelated email accounts or authors when displayed in the email recipient's email system. For example, when an employee of Coca-Cola sends an email to a recipient, all or part of the email address of the employee may be displayed in the recipients email system in the customized font used in the Coca-Cola logo. When the recipient opens their email system, they will be able to quickly and easily identify the email sent from the Coca-Cola employee due to the appearance of the account's email address.

Other embodiments provide for enabling at least one action to be performed with respect to the field, for example, by incorporating a URL into the displayed field. Alternatively, and included within the scope of the invention is the customization of message fields, using any of the elements and principles of design, such as the modification or substitution of, or composition of any suitable digital media, such as font, style, size, colour or visual representation such as symbols, or embedded material.

Some electronic mail, or email, is a method of exchanging messages in digital format from a sender to one or more recipients, and has two primary components:

1. The message header: comprising control information such as the sender's email address, the recipients email address and other descriptive information such as the subject heading and date/time stamp; and

2. The message body: comprising text (for example, in either text format or HTML), and or other file attachments.

There are a number of internationally recognised “Internet Message Formats” which provide that the message header include at least the following fields:
“From”: the email address, and optionally the name or nickname of the sender and receiver; and
“Date”: the time and date of when the email was transmitted by the sender;

and should include at least the following fields:

“Message-ID”: used to prevent multiple delivery; and
“In-Reply-To”: used to link related messages together.

Other message header fields may (and often do) include:
“To”: the email address, and optionally the name or nickname of the recipient(s);
“Subject”: a brief summary of the topic of the message:
“Bcc”: lists the address(e) that are added to the delivery list but remain unseen by the other recipients;
“Cc”; lists the address(es) that are added to the delivery list but are not intended as the primary addressee of the email;
“Content type”: provides information about how the body of message is to be displayed;
“Precedence”: may be used to indicate the value or status of an email (such as “bulk”, “junk” or “list”) or other values of relevance to the recipient such as “out of office”;
“Reply-To”: the address that should be used for any reply to the email;
“Sender”; the actual sender of an email on behalf of a sender; and, for example
“Archived-At”: a link to the archived form of an email.

It will be appreciated that in most email clients, only some of these header fields are displayed, and that this may be dependent on how the receiver email system is configured which again can be dependent on the software used by the receiver email system.

Current message formats limit the type of characters that can be used in header fields. Originally, header fields were restricted to the use of ASCII characters, More recent message formats allow for the use of Unicode characters, however, such message formats do not allow for the sender to control the appearance of the characters.

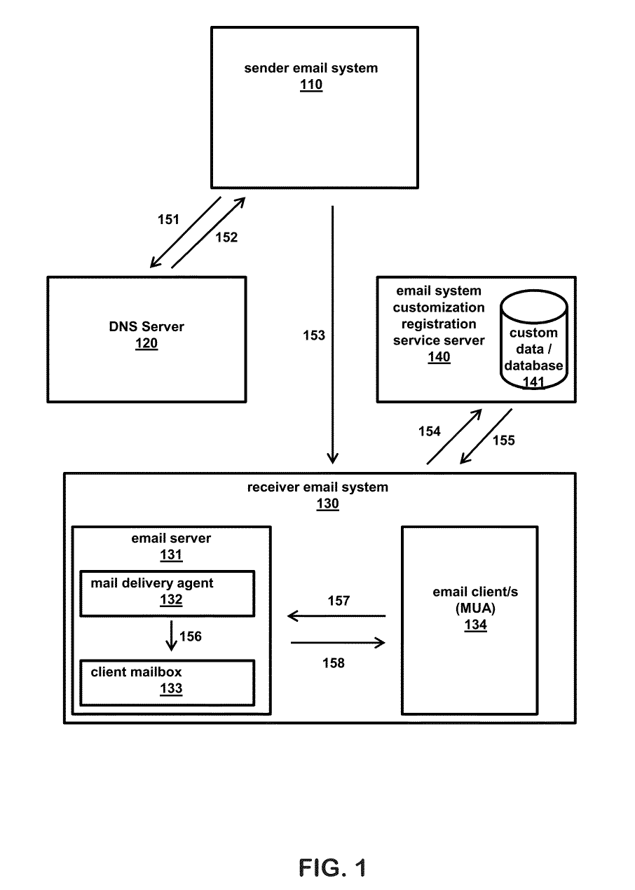

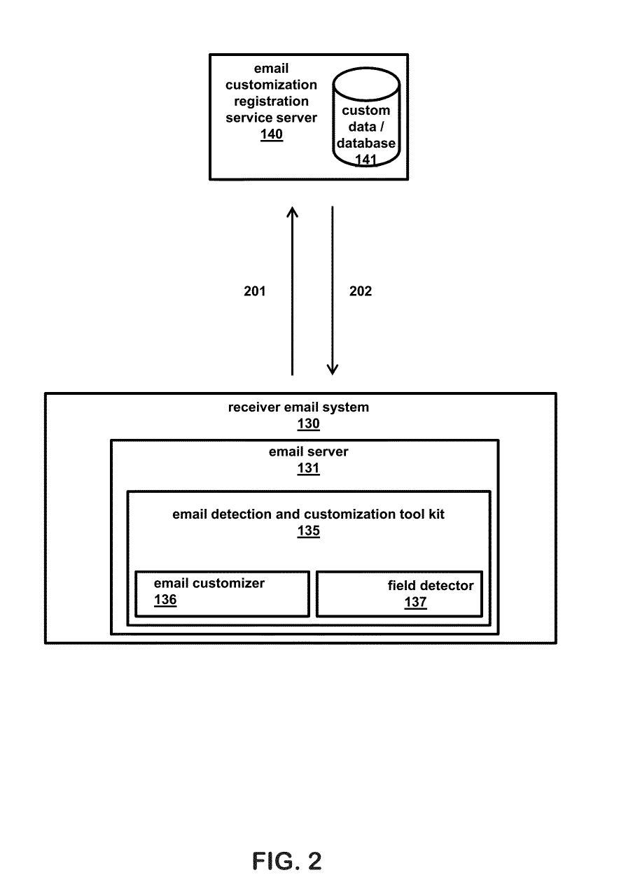

An embodiment of a messaging system in the form of an email system is shown in FIGS. 1 and 2. FIG. 1 shows the process of a sender emailer system 110 sending an email to a receiver email system over the Internet (not shown), the receiver email system 130 retrieving custom header data from an email customization registration service server 140, and thereafter controlling how at least one displayed field of the header is displayed in the receiver and sender email system.

FIG. 1 shows a scenario where the receiver email system 130 comprises an email server 131 and email client(s) 134. However, persons skilled in the art will appreciate that the invention can be extended to other configurations. For example, some email systems use an additional server (sometimes run by a third party) to receive and filter, for example, emails for spam before it is passed to email server 131. The client can be provided by any electronic device which is arranged to communicate over a network, such as the Internet, to receive emails, such as a computer, tablet, mobile phone, handheld gaming device, personal digital assistant (PDA), television or any other suitable device. Persons skilled in the art will also appreciate that the invention can be extended to web-based email systems where user's access emails via a browser, or any other email system, using at least an electronic communication element.

In the scenario of FIG. 1, it is assumed that the sender email system 110 is already registered with email customization registration service 140. An email is composed by a mail user agent (not shown) of a user within the sender email system and is addressed to a user within the receiver system 130. The sender email system 110 resolves the domain name of the of the mail server from the email address and asks 151 the DNS server 120 for the any MX records for the mail server for that domain. The DNS server responds 152 with the MX records listing the mail server. The sender email system then sends 153 the email to the mail server identified by the DNS server 120, in this case receiver system email server 131. Other references to FIG. 1 will be shown also in FIG. 2.

FIG. 2 shows that an email detection and customization tool kit 135 is installed on the email server 131 of the receiver email system 130. In one embodiment, a domain detector function 137, detects the domain of each incoming email (e.g. by extracting it from the email address) and sends the domain as part of a request 154 (as seen in FIG. 1) for custom field data to the email customization registrations service server 140. Persons skilled in the art will appreciate that the domain is information indicative of at least part of the email address.

With reference to FIGS. 1 and 2, persons skilled in the art will appreciate that there may be more than one server 140 as part of the email customization registration service. Where there is more than one server 140, they may store duplicates of the custom data or a subset of the data (e.g. specific to a set of domains).

The email customization registration service server 140 searches the custom data (which may be indexed by at least part of a field, or part of an address) for any custom field data in custom data database 141 and responds 154 with either the custom field data or a “no custom data message”.

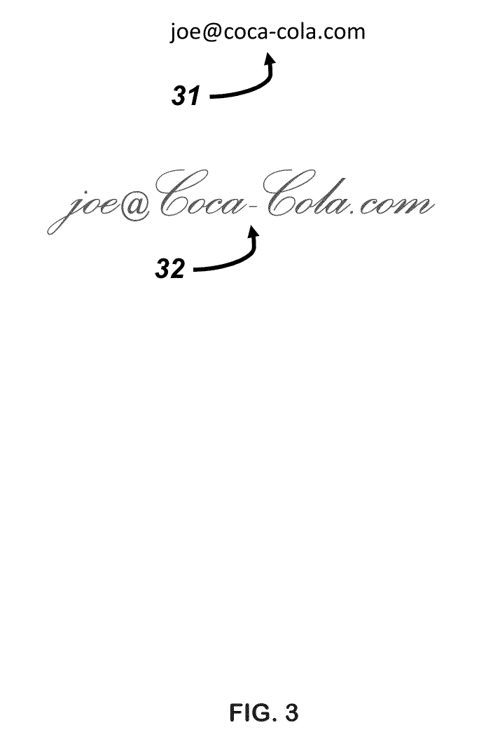

If custom field data is found, it is added to the email message by the email customizer before the mail delivery agent 132 delivers 156 the email message to the client mail box. Accordingly, when the email client 134 makes a request to retrieve 157 email message(s), the email message is sent 158 from the client mailbox with the custom data to thereby control display of the email to the user. Persons skilled in the art will appreciate that the email server could also push the email to the client. Examples of custom displays of email addresses are shown in FIGS. 3 to 8 as described in further detail below. If a “no custom data message” is received, the email fields are displayed in a default font.

As described herein, the custom field data may correspond to the visual appearance of one or more of the message fields as displayed on the receiver email such as an alternative font to the standard default font of the recipient email system.

The term “font”, and related terms such as “fonts”, as used in this specification typically refers to a computer font or file with font that can be used by at least part of an email system. A font may provide a resource or file containing a visual representation of characters and may comprise information that maps character codes to shapes or glyphs that represent such characters. Fonts sharing a common design style may be grouped into font families classified by a set of standard font properties. Within such a family, the shape displayed for a given character can vary by stroke weight, slant, relative width, or other aspects, properties or characteristics. A font may be described by a unique combination of such aspects, properties or characteristics. A font may comprise a bitmap font format, an outline font, a stroke-based font, or any other suitable font system employed or used by an email system. Additionally, for example, fonts may include or be Serif, Sans-Serif, Monospaced, Script, Blackletter, Non-Latin (for example, non-English language based fonts such as a Japanese font), Dingbat or Symbol-based fonts, display or decorative fonts, simulation or mimicry fonts, or any other suitable font system.

The customization may be in the form of displaying any part of an email field, including a customised email address, a customized email address nickname, identification, or a combination thereof Customizations to the appearance can include any element and principles of design (as known in the design industry), including for example, changing the font of the email address or replacing the text characters with images or vector graphics. The customisations can apply to all or any specific part of a field. For example the customization may only apply to the domain portion, or to some or all the characters prior to the ‘@’ symbol, the ‘@’ symbol itself, or to the entire address, name, nickname, or other identification. Customizations can be case sensitive if chosen. A URL for the email address can also be specified that will direct a user to the URL when the email address is interacted with via a user interface, for example via a tap or click. The customization can include, for example, an image or images. A suitable image may be a trade mark, or service mark. Other customizations can be colour, size, formatting etc. Any elements and principles of design as referred to may be employed to achieve a desired result

Persons skilled in the art will appreciate that rather than extracting the domain, the domain detector could send the entire email address to the email customization registrations service server 140. In one embodiment, this allows for more than one customization within the same domain. This might allow different divisions of a company responsible for different products to customize their name differently. Similarly, it allows for individuals using a web-based email service to customize their individual names. In another embodiment, it is left to the email customization registration service server 140 to extract the domain or part of the domain from the email address to search custom data 141. In another embodiment, the custom data is stored and searched for, based on matching a name and or nickname, which is not lead through a hierarchy search starting from the domain name part of the address.

In one embodiment, the receiver email system is arranged to store any retrieved custom data in a local database (not shown), In this embodiment, domain detector 137 is arranged to perform an initial search of the local database before sending the request to the email customization registration service server 140. If domain detector 137 locates any locally stored custom field data it passes it to email customizer 136 to customize at least one displayed field of the email. In some embodiments, this allows a customized field to be displayed to a recipient without retrieving custom field data even if the recipient has not previously received an email from the sender.

In some embodiments, the domain detector 137 may be arranged to confirm that custom data used in this manner is still current. For example, by sending a request to the email customization registration service server 140 if the data has not been used within a defined time period. Such a request can be sent as a lower priority request or a batch of such request can be sent together in order to reduce the burden on the email customization registration service server 140 and maintain its capability to respond promptly when a request for new data is received.

FIG. 2 shows the process of customizing an email field, being an address, or email address nickname, name or identification, saving and storing same, and later accessing saved results for review or change. FIG. 2 shows the email customization tool kit 135 can be used by a user to log-in 201 to the email customization registration service server 140 in order to customize an individual email address or an email address nickname or such like or to customize email addresses for an entire domain, a single email address, or an email address nickname or representation. Once this is done, with the design parameters set, the details are saved and in custom database. A user can later log on and review 202 their customization and make changes to their design details if necessary.

A user account is required to save the changes. On account creation the user is required to supply proof of ownership or sufficient management rights of the email, or email domain to have sufficient rights to save the customisations. Users are required to authenticate prior to making modification to the appearance of an email address. In order for an email client to obtain a valid authentication token they will be required to supply sufficient proof of ownership, or rights the email address during the registration process.

In one embodiment, an email client can see the customizations previously made to the email address any given time, for example, they may be displayed in the composition interface of the email client.

In one embodiment, the email detection toolkit is a code library or database that can be interacted with, that allows for the detection of a customized email field. The code library or database also assists developers of the email field appearance, to modify the appearance of the email fields, including email addresses as would be displayed on a sender or receiver email system.

In an alternative embodiment, the email customization and detection tool kit could be deployed with and used by an email client. In one example of such an embodiment, an email client (Outlook, Gmail, Calender application, etc) displays an email address or nickname or representation, to user. Initially the email address is displayed in the standard or default font.

The email client uses the email detection tool kit to identify all the email addresses it is currently displaying. Once the email detection toolkit has detected the email addresses and/or nicknames, or representations, it attempts to find a matching customization for the email. This can be found either via a local storage (e.g. on the server) or by making a request to the email customization registration service 140.

The email customization registration service 140 responds to the request from the email detection toolkit. The response contains the information for the matching design, for example, font or image data relating to the email. The email client then uses the information to update the rendered appearance of the email address to match the registered corporate or personal identity.

In some embodiments, the sender system may also look up the custom data. In this respect, the sender messaging system (e.g. email system) may be arranged to perform a look-up when the sender enters an address such as an email address in a manner similar to the receiver system on receipt of an e-maul. The sender system may perform the look-up in the background while the user is composing the email. Alternatively, the sender system may perform a look-up after an email is sent and update the representation of the field in the sender email system afterwards to assist the user in navigating their sent items.

FIG. 3 shows an example email address 31, written in “Calibri” font. This is to exemplify an apparent representation of a standard non customized email address. Item 32 shows the same text based email address as item 31 however, the font has been customized in item 32 so that at least a portion of the email address is in different font to that of item 31. This is to demonstrate an example of the customization process and its affect on at least a portion of a field in a message system.

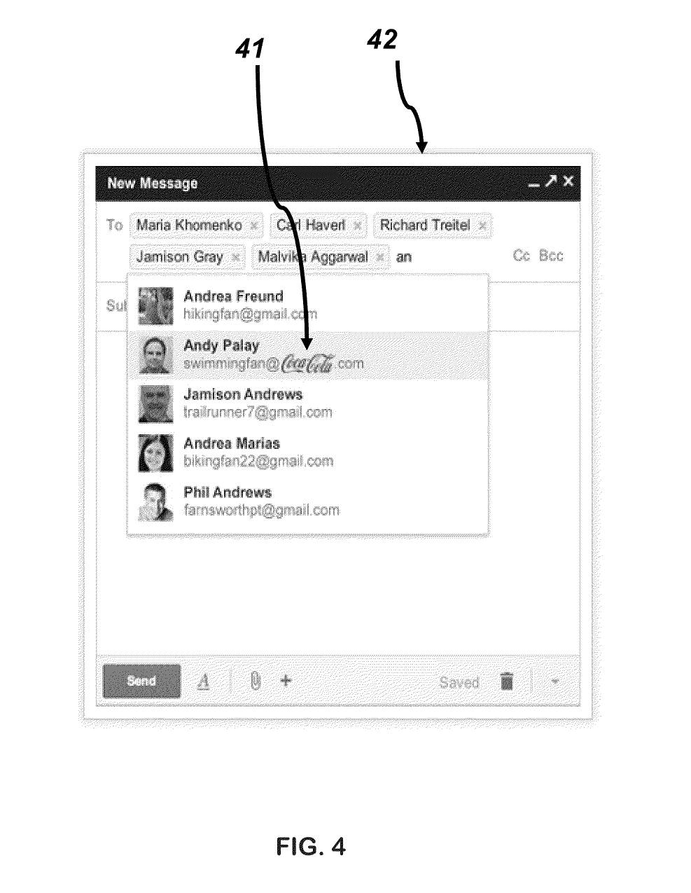

FIG. 4 shows an example of at least a portion of a customized field, such as an email address, in an email customization interface 42, wherein at least a portion 41 of an email address has been customized, in a message system.

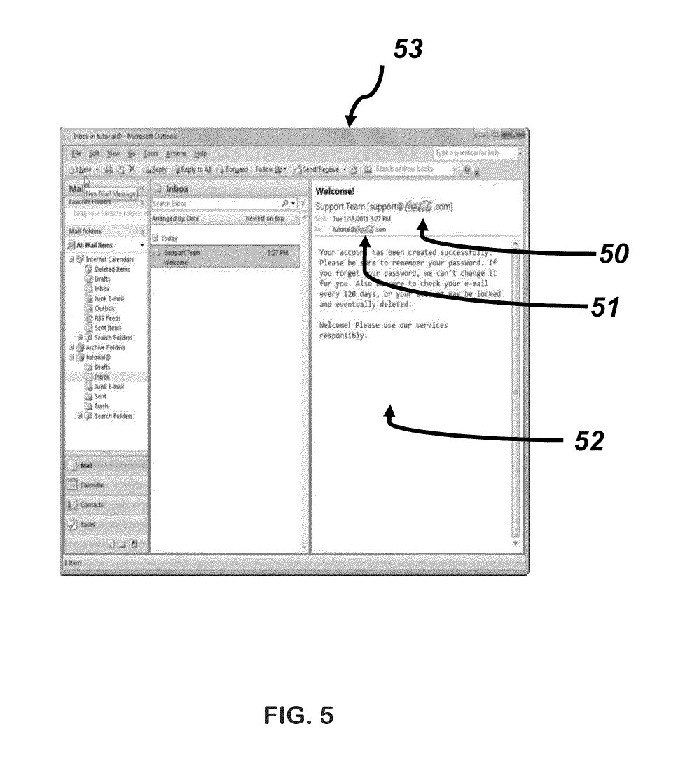

FIG. 5 shows examples wherein at least a portion of a message system field is customized, such as at least a portion of an email address, 50 and 51 in a reading pane 5 of an interface 53 of an email client.

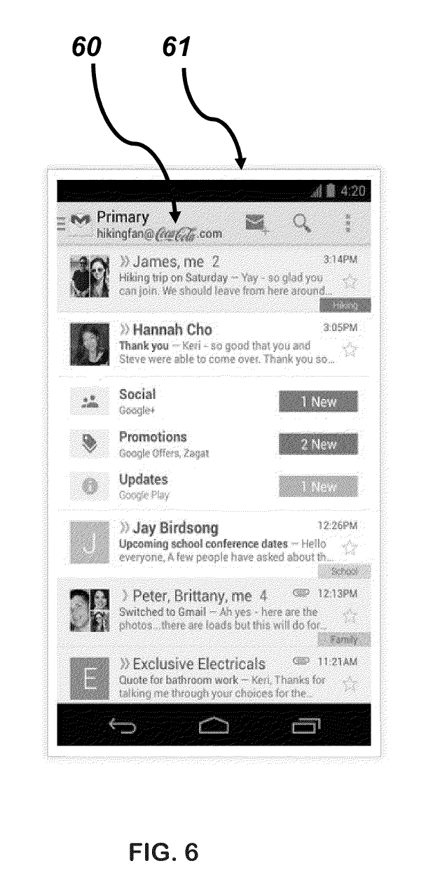

FIG. 6 shows an example where at least a portion of a field in a message system has been customized, such as an email address 60 of a user, shown in a display of the contents of the user's own inbox, via an interface 61 of an email client. In this example, the user can see the customization applied to their own emails. In a similar way, at least a portion of a customized email field may also be able to be seen in the sent items list, of emails which have been sent, whereby the email customization system would have been used.

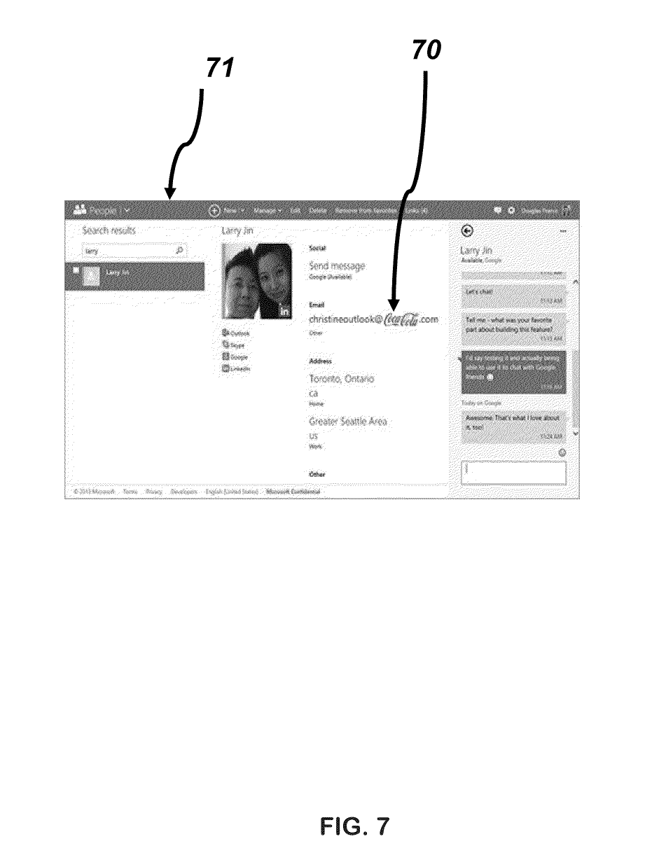

FIG. 7 shows an example wherein at least a portion of a field in a message system, such as an email address 70, has been customized, as shown in a contact entry 71, This example could be suited to embodiments where the custom data is stored locally by the email server or the client.

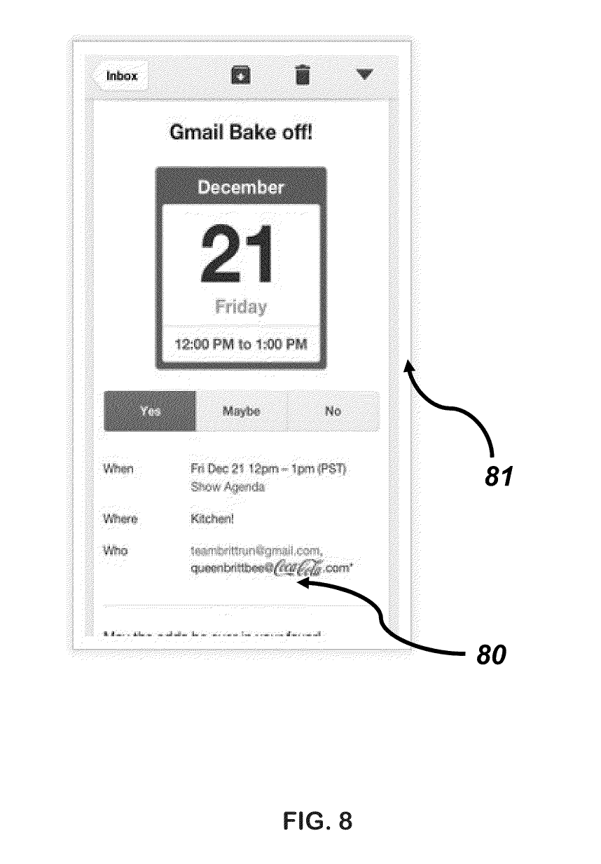

FIG. 8 shows an example wherein at least a portion of a field in a message system, such as an email address 80, has been customized, in a calendar entry 81.

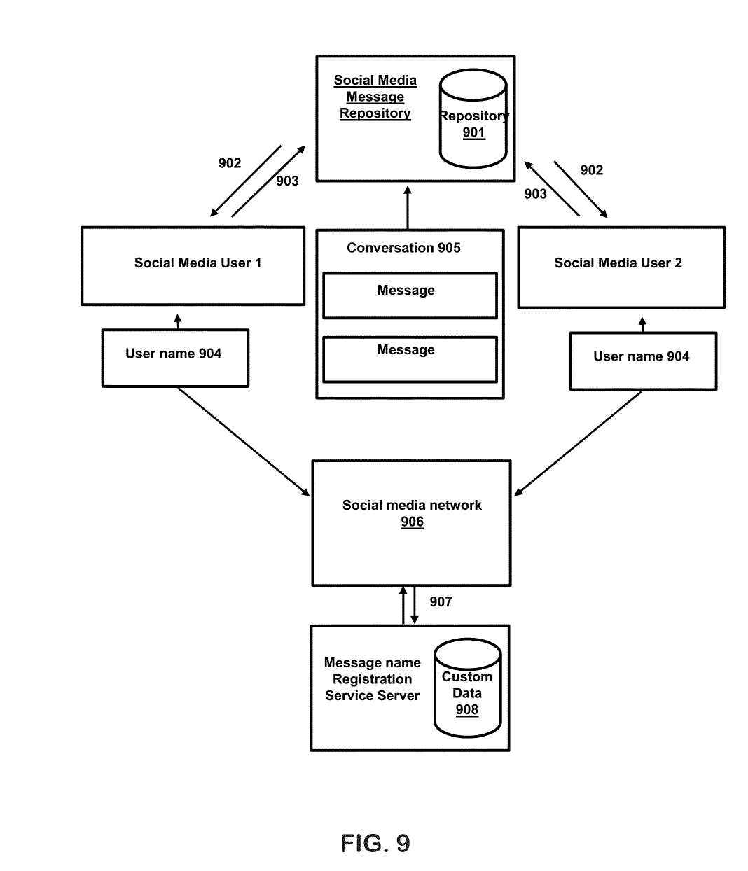

FIG. 9 shows a schematic representation example of a social media or social network message system. Customisation of at least a portion of a field in, a message system, such as an email system, and in particular, for example, and email field (as described herein) can be used as at least as a representational equivalent to customization of at least a field in a social media or social network message system . This social media or social network message system differs from the previous email system implementation because of the difference in architecture of communication process. Where the standard email is simply sent from a sender to a receiver, in the case of social media or social network message system, there is a repository for each message 901. This repository as described in FIG. 9 is interacted with by both sender and receiver. Each social media or social network user sends and receives from this central repository of messages 902 and 903.

Each user has at least an identification such as a name associated with their account 904. A conversation is created when social media or social network users send a message to each other and is stored in the repository 905. When users read messages from the conversation, each of the user's identification such as name, nickname, or other identification information presented from the conversation are displayed. The display of the user's displayed identification (as referred to) is independent from the conversation and is managed by the social media or social network 906 message system. The social media or social network message system then is responsible for querying 907 the user identification display customisation with the registration service 908, and obtaining relevant results to display. A user that chooses to customize at least a portion of a field, such as their identification display (as referred to), can be customized in any was desired, and stored in the custom data 908 registration service, or database. Such customization can be achieved in at least in a similar way to that as described herein, for the email field message system customization system. For example, this would include securely logging on to message system, to manage and customize chosen field to desired parameters, wherein same would be stored in custom data 908.

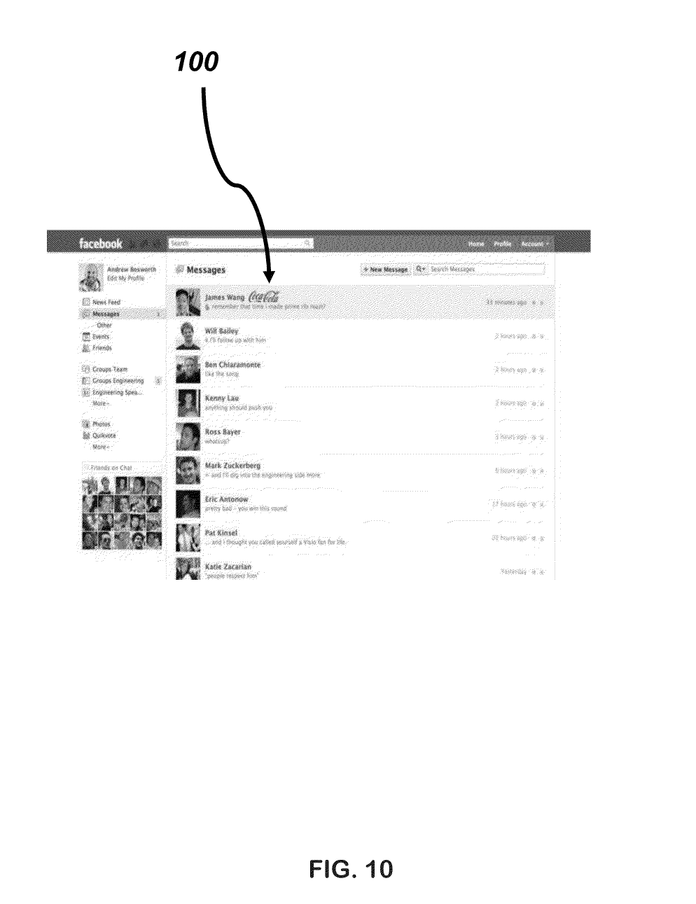

FIG. 10 shows a design layout example of the invention including a message system relating to social media or social network wherein a customized display 100 is included as part of a users identification display (as referred to).

In another embodiment example of the invention, the custom data may be displayed on web based communications platforms allowing for synchronous or asynchronous communications on a central server. In such an embodiment, at least a portion of any custom field(s) could be customized. Such customized data could be displayed to the message user, such as sender and or recipient, on said communications platform. In such an example, the communications platform may send a request for custom field data to an email customization registration or database service in response to receipt of a message having at least a portion of a field that can be identified, and matched, for example. The message system customization registration or database service may send a single packet of custom data to the communications platform allowing the communications platform to display at least a portion of field with custom data of the sender, or may send custom data to the communications platform each time a message is sent by the sender through the communications platform and received or viewed by the receiver. Examples of such communications platforms include but are not limited to platforms such as those known as Google Wave and or Wave in a Box, or any other such platform where this example embodiment could be used.

For clarity, the following words and terms below are provided with definitions that are to add to the dictionary and contextual meaning of such words used in this document, and which apply to this document:
1 “field”: area for a header in an email, and equivalent to the identification reference for a party using social media or social network, such as twitter identification, and equivalent to a phone number, or text number identification, or the like;
2 “body”: the bottom area of an email construct, and also the equivalent of a social media or social network content area, or SMS text content, or the like;
3 “customization”: purposely designing something, or aggregation, compilation, assimilation, arrangement, positioning, even to the extent of randomly changing the position of original positioned items, or such like, hence having a method or plan to change something;
4 “message system”: as referred to herein, and includes any process system, method, application, representation, and or electronic, digital, analogue, or other electrical powered, or other ability for contact, to be made;
5 “nickname”: abbreviation of a name, made up name, identification, replacement of email address or used in conjunction with email address, or used in any contact point, contact area, or profile display or system:
6 “address”: contact point for an entity, such as an email address, telephone number, social media or social network message contact reference, or the like;
7 “custom data”: information or data that falls under “customization”;
8 “pop-up”: as known on the internet, a note that pops up with information on it, prior to moving onto next web site, or such like;
9 “identification”: data or information that represents or relates to an identity;
10 “ID”: abbreviation for identification, or identity;
11 “contact point”: particular details of means to contact an entity, such as an email address, a telephone number, a social media or social network contact ID, or such like;
12 “contact details”: information that makes up contact point, or displayed representation of contact related information;
13 “reference point”: details representing an ID, or such like;
14 “header field”: a field in a top area on an email, or suck like; and
15 “message system customization registration service”: management system to store customized information or data relating to message system, and such can otherwise be called a database, or server, or storage related thing.

It is to be noted that these example words and terms with extended definitions are examples, and it is possible there could be more added to this list. However, these are a good basis to work from for clarity.

In some embodiments, the customization of the field(s) may be undertaken in the message delivery and receipt system of a social media or social network systems. In this way, the invention as described herein, could apply to any message system fields, including within a social media or social network message system, that a person skilled in the art would consider equivalent to the message field(s) of message system as referred to herein relating to an email system. Social media or social network sites such as Facebook or LinkedIn typically provide users with the ability to send written messages to other members of the same social media or social network platform. Such messages, when viewed by the message recipient, include at least a field that may be considered equivalent to at least one of the “From”, “To” or other fields in an email. A person skilled in the art would therefore realise that this invention may also be applied to the customization of at least a portion of a message field by, for example, the sender of a message within a social media or social network message system that could display customised data when viewed by the recipient, via utilization of the customization process as referred to herein.

In a further embodiment example, at least a form of an equivalent of the email customization registration service may be implemented within a social media or social network message system (see FIG. 9). In such an embodiment example, upon receipt of a message within a social media or social network message system platform, the recipient's platform account would send a request for information to the message system customization registration service for custom field data, and upon the receipt of custom field data (such as the “From” field in a social media or social network message system), the received message is displayed in the recipient' platform account in a customized format. The message system customization registration services could be part of the social media or social network system, or may be provided by third parties external to the social media or social network system.

It is to be noted, that reference to a user is an entity that uses or interacts with a message system (referred to herein) and is at least a person, organisation, group, business, corporation, entity, party, or such like, and so on.

It is to be noted, that reference to customize means to set at least a parameter relating to the design (which includes any of the design elements and principles as known in the design industry, as referred to herein), of an item, or appearance of something. Further, customize is to be read to include aggregation, compilation, arrangement, locating, or such like, of information or data, or any other way or method of putting together, or arranging at least an element of a design feature, so as to change, and thus customize an item, as opposed to such an item that would have otherwise been displayed in a default setting, style, design, or such like.

It is to be noted, that with a medium connected to the internet, user can access a portal, and with sufficient identification and security passing features, for example, username and password, and set up, and customize their profile of at least a portion of a field in a message system (as referred to herein). The profile covers all information relating to the user, for example name, email address, email address nickname, or other indentifying information such as a representation, or reference point information, and items that can be customized include all those mentioned herein, and can include telephone number, mobile telephone number, address, photograph(s), text message(s), and any other information relating user, which is seen or not seen by other parties when using a message system.

The message systems referred to herein can be used on any electronic communication device applicable, and with any software or platform applicable. Examples of the platform include any communication system, such as social media or social network systems, for instance, Facebook, Google+, Tumblr, Twitter, Nexopia, LinkedIn, Monstercom, Foursquare, Gowalla, Yelp, and MySpace, and the like, and so on.

The message systems referred to herein can also be used on other communication systems including dating services such as Match.com, Yahoo Personals, eHarmony.com, and the like, and so on.

The message systems referred to herein can also be used on other communication systems including education related services such as Ning, TermWiki TeachStreet, and MyYearbook, and the like, and so on.

The message systems referred to herein can also be used on other communication systems including other communication systems including Instant Messaging, LAN Messenger, Multicast or that Rooms, Contact List or Buddy Lists or Friend Lists, and the like, and so on.

The message systems referred to herein can also be used on other communication systems including open source software to use for social media or social network services including

Anahita Social Networking Engine, Diaspora, Apple seed Project, OneSocialWeb, Kune, StatusNet, and Tent, and the like, and so one These technologies are often referred to as social engine or social networking engine software,

The message systems referred to herein can also be used on any form of communication systems including any network, internet, satellite, GPS, mobile telephone, and the like, and so on, and can be used by any medium to connect to a network, or the internet and use any message system referred to herein.

It is to be noted, this Invention is a method, system, process, application, and product, whereby a user can customize a field in a message system, and a profile in a message system, which uses any applicable software and programming (as referred to herein), viewable on any applicable device or medium (as referred to herein).

It is to be noted, this invention can be viewed by at least a party when on an applicable device or medium. In some other examples, the invention, can be used, or set up, by a party that is not the and profile user, for example, when profile is set up on a mobile telephone. The end user may then have veto over the profile, via software or applicable platform, and or with relevant settings, for example, of relevant message system field and or profile information that is customized, so that control is maintained by invention user, wherein in this case, the user is a receiver of, for example a telephone call and telephone text message, and based on this, with the appropriate system and abilities, can then customize an applicable field or profile in a message system of another parties details, including such customized items that may appear on the receivers network device (as referred to herein).

For any of the message systems referred to herein, all programming and software required to support such message systems can installed as need be on each relevant, required, or chosen component or platform along the communication network. This includes any and all systems, which can include, for example, any communication related product or system used by a user, or a viewer, This can also include a system whereby the customization of at least a portion of a field in a message system, can be achieved by a viewer or recipient of a different party.

It will be understood to persons skilled in the art of the invention that many modifications may be made without departing from the spirit and scope of the invention. For example, in FIG. 1, the email customization registration service 140 is shown as separate to the receiver system, whereas it could be incorporated within the receiver system. For example, if the receiver system is a web-based email system, the email customization registration service 140 could be used to allow only users of that system to customize their email addresses.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In the claims which follow and in the preceding description of the invention, except where the context requires otherwise due to express language or necessary implication, the term “click” or variations such as “clicks” includes the term “double click” or suitable other GUI manipulation functions such as rolling a cursor, or sliding a finger an a touch screen, etc.

It is to be understood that, if any prior art publication is referred to herein such reference does not constitute an admission that the publication forms a part of the common general knowledge in the art in any country.

1. A method of providing customization of at least one displayed field in a receiver message system, the method comprising:
receiving a message at a receiver message system, the message comprising at least a field and a body;
sending a request for custom data from the receiver message system to a message customization registration server, the request for custom field data comprising information indicative of at least a portion of an address contained in a field;
receiving custom data from the message customization registration server at the receiver message system upon the at least a portion of the address being registered with the message customization registration server, wherein the custom data relates to at least one of a desired appearance of data in at least one displayed field and an action that can be performed with respect to the at least one displayed field; and
controlling at least one of the appearance of the contents of the at least one displayed field and an action that can be performed with respect to the at least one displayed field when the message is displayed by the message system based on the custom data.

2. The method as claimed in claim 1, wherein the message system is an email system and the address is an email address and information indicative of at least a portion of an email address is a domain name that forms part of the email address and custom data is received if the domain name is registered with the message customization registration server.

3. The method as claimed in claim 1, wherein the message system is a social media or social network system, an SMS (short message service) or text message system, a telephone call system, or any other message system, and the address is the “ID” (the “ID” being the identification number, address, or contact detail(s)) wherein custom data is received if at least part of the ID that forms part of the address is registered with the message customization registration server.

4. The method as claimed in claim 1 comprising:
receiving a negative response from the message customization registration server at the receiver message system if the information indicative of at least a portion of a message address is not registered with the message customization registration server; and
displaying each displayed field in a default font in response to the negative response.

5. The method as claimed in any one of claim 1, wherein custom data related to an action that can be performed with respect to the at least one displayed field which comprises a URL placed in the at least one displayed field to enable a user to access a pop-up and or a web page corresponding to the URL by operating a user interface to select the URL.

6. The method as claimed in claim 1, comprising storing the custom data in a local database of the receiver message system.

7. The method as claimed in claim 6, comprising searching the local database for any stored custom data corresponding to the information indicative of at least a portion of an address prior to sending the request to the message customization registration server, and controlling at least one of the appearance of the contents of the at least one displayed field and an action that can be performed with respect to the at least one displayed field when the message is displayed by the message system based on any stored custom data located in the search.

8. (canceled)

9. A non-transitory computer readable medium having stored thereon computer readable instructions that, when executed by a processor, cause the processor to perform the method of claim 1.

10. A message customization registration server comprising:
a database of custom field data indexed by at least a portion of an address, wherein a custom field data entry relates to at least one of a desired appearance of data in at least one displayed field and an action that can be performed with respect to the at least one displayed field and can be used by a receiver message system to control at least one of the appearance of the contents of the at least one displayed field and an action that can be performed with respect to the at least one displayed field when the message is displayed to a user by the receiver message system; and
the message customization registration server comprises a processor that is configured to:
receive a request for custom field data from a receiver message system comprising information indicative of at least a portion of a field or address,
search the database of custom field data based on the received information indicative of at least a portion of an address, and
send any located custom field data to the sender and or receiver message system based on the received custom data.

11. The message customization registration server as claimed in claim 10, wherein the message system is an email system and the address is an email address and wherein the at least a portion of an address comprises a domain name.

12. The message customization registration server as claimed in claim 10, wherein the message system is a social media or social network system, an SMS (short message service) or text message system, a telephone call system, or any other message system, and the address is the “ID” (the “ID” being the identification number, address, or contact detail(s)) wherein custom data is received if at least part of the ID that forms part of the address is registered with the message customization registration server.

13. The message customization registration server as claimed in claim 10, wherein the request for custom field data comprises the entire address, and the customization registration server is arranged to extract at least one portion from the entire address to search the database.

14. (canceled)

15. (canceled)

16. (canceled)

17. (canceled)

18. (canceled)

19. (canceled)

20. (canceled)

21. The message customization registration server as claimed in claim 10, wherein the database of custom field data is indexed by at least portions of an address, the message customization server arranged to receive a request for custom field data from a sender or receiver message system, search the database of custom field data based on the received information indicative of at least a portion of an address, and send any located custom field data to the receiver message system.

22. The method as claimed in claim 1, wherein the message system is an email system and the address is an email address and the at least a portion of an email address comprises a domain name.

23. The method as claimed in claim 22, wherein the request for custom field data comprises an entire email address, and the message customization registration server is arranged to extract at least one portion from the entire email address to search the database.

24. (canceled)

25. (canceled)

26. (canceled)

27. (canceled)
